(19) United States
(12) Patent Application Publication
(10) Pub. No.: US 2026/0366554 A1
(43) Pub. Date: Nov. 19, 2026

(54) FIXING STRUCTURE OF TELESCOPIC PIPE

(71) Applicant: CHIEN-TING LIN, Santa Fe Springs, CA (US)

(72) Inventor: CHIEN-TING LIN, Santa Fe Springs, CA (US)

(21) Appl. No.: 19/210,872

(22) Filed: May 16, 2025

(51) Int. Cl. F16B 7/14

(52) U.S. Cl. CPC F16B 7/149

(57) ABSTRACT

A telescopic tube assembly having a fixing structure includes an outer tube having a receiving end, wherein at least one hole is disposed adjacent to the receiving end; an inner tube; an outer tube insert accommodated in a gap between the outer and inner tubes, and having at least one external threaded portion passing through the hole to outside of the outer tube; and a sleeve member sleeved on an outer side of the outer tube, and having an internal threaded portion corresponding to the external threaded portion, wherein by rotating the sleeve member, the internal threaded portion and the external threaded portion are tightened with each other, such that the external threaded portion is pressed by the sleeve member, thereby making the outer tube insert directly press against the inner tube tightly, and fixing the inner and outer tubes to each other.

### FIELD OF THE INVENTION

The present invention relates to a telescopic tube assembly having a fixing structure, and more particularly, to a telescopic tube assembly having a fixing structure that includes an outer tube insert with an external threaded portion.

### THE PRIOR ARTS

In an existing telescopic tube assembly having a fixing structure (for example, a clamping sleeve), the clamping sleeve is arranged at a connection between the inner and outer tubes of the telescopic tube assembly, that is, arranged on the outer side of the end portion of the outer tube. The clamping sleeve has a fastening function. When the clamping sleeve is tightened, the tubes of the telescopic tube assembly are fixed and non-movable relative to each other, and when the clamping sleeve is loosened, the tubes of the telescopic tube assembly are movable relative to each other.

In the existing telescopic tube assembly having a fixing structure, a threaded portion is directly formed on the outer side of one end of the outer tube by machining, and the clamping sleeve having an internal threaded portion and the outer tube having the external threaded portion are tightened with each other, thereby causing the inner side of the clamping sleeve to press against a pressing member sleeved at the outer side of the inner tube, and then making the pressing member press against the inner tube, so as to fix the telescopic tube assembly.

In another existing telescopic tube assembly having a fixing structure, a screw thread is formed on a separate workpiece, which is then connected to one end of the outer tube through assembly or adhesion. In this way, the screw thread is disposed adjacent to one end of the outer tube and extends beyond the end of the outer tube. Therefore, the clamping sleeve needs to be lengthened to fully cover the screw thread and the connection portion of the outer tube; otherwise, structural instability and poor appearance may occur.

However, in the existing telescopic tube assembly having a fixing structure, forming a threaded portion on the outer side of the outer tube requires a complicated machining. The outer tube must have a certain thickness to form the threaded portion, which consumes more material. The connection of the screw thread to the outer side of the outer tube also consumes more material and has a risk of detachment. Therefore, the existing structure is relatively wasteful of resources and lacks sufficient stability.

### SUMMARY OF THE INVENTION

To solve the problems of the existing telescopic tube assembly having a fixing structure, the present invention provides a telescopic tube assembly having a fixing structure, in which an external threaded portion of an outer tube insert passes through a hole of the outer tube, such that the outer tube insert is accommodated in a gap between the outer tube and the inner tube, thereby preventing the outer tube and the inner tube from detaching and instability; and by forming a screw thread on the outer tube in a simple manner the screw thread can be tightened with an internal threaded portion of the sleeve member, thereby achieving the effect of fixing the inner tube and the outer tube. The present invention can not only maintain the convenience in use, but also save the consumption of resources and increase the stability of structure.

The technical solution of solving the technical problems used by the present invention is to provide a telescopic tube assembly having a fixing structure, comprising: an outer tube having a receiving end, wherein at least one hole is disposed adjacent to the receiving end; an inner tube having an outer diameter smaller than an inner diameter of the outer tube; an outer tube insert accommodated in a gap between the outer tube and the inner tube, and having at least one external threaded portion, wherein the number of the at least one external threaded portion is less than or equal to that of the at least one hole on the outer tube, and positions of the at least one external threaded portion and the at least one hole are corresponding to each other; and the external threaded portion passes through the hole and a screw thread of the external threaded portion protrudes out of the outer tube; and a sleeve member sleeved on an outer side of the outer tube, and having an internal threaded portion, wherein a screw thread of the internal threaded portion has a shape corresponding to that of the external threaded portion, and the screw thread of the internal threaded portion and the screw thread of the external threaded portion is capable of being tightened and loosened from each other; wherein in assembling, the outer tube insert is placed inside the outer tube, the external threaded portion passes through the hole, and then one end of the inner tube passes through the receiving end and is placed inside the outer tube, such that the outer tube insert is accommodated between the outer tube and the inner tube; the sleeve member is sleeved on the receiving end, wherein by rotating the sleeve member, the internal threaded portion and the external threaded portion are tightened with each other, such that the inner tube and the outer tube are fixed to each other; and by reversely rotating the sleeve member, the internal threaded portion and the external threaded portion are loosened from each other, such that the inner tube and the outer tube are movable relative to each other.

Preferably, by rotating the sleeve member, the internal threaded portion and the external threaded portion are tightened with each other, such that the outer tube insert directly press against the inner tube tightly, thereby fixing the inner tube and the outer tube to each other; and by reversely rotating the sleeve member, the internal threaded portion and the external threaded portion are loosened from each other, such that the external threaded portion is loosened from the sleeve member, thereby making the outer tube insert no longer directly press against the inner tube, and allowing the inner tube and the outer tube to be movable relative to each other.

Preferably, the telescopic tube assembly having the fixing structure further comprises an inner tube pressed member having a pressed portion, which is disposed around an outer side of the inner tube and is movable relative to the inner tube and accommodated in a pressing-accommodating portion of the sleeve member, wherein the pressing-accommodating portion is provided with a pressing portion, and positions of the pressing portion and the pressed portion are corresponding to each other, and wherein by rotating the sleeve member, the internal threaded portion and the external threaded portion are tightened with each other, such that the pressed portion is pressed by the pressing portion, thereby making the inner tube pressed member directly press against the inner tube tightly, and fixing the inner tube and the outer tube to each other; and by reversely rotating the sleeve member, the internal threaded portion and the external threaded portion are loosened from each other, such that the external threaded portion is loosened from the sleeve member, thereby making the inner tube pressed member no longer directly press against the inner tube, and allowing the inner tube and the outer tube to be movable relative to each other.

Preferably, the inner tube pressed member has one or more groove(s).

Preferably, the inner tube pressed member and the outer tube insert are formed as one piece.

Preferably, the outer tube insert is a sheet-shaped body.

The beneficial effect of the present invention is that the external threaded portion of the outer tube insert is tightened with the internal threaded portion of the sleeve member by making the external threaded portion of the outer tube insert passes through the hole of the outer tube, so as to achieve the effect of fixing the inner and outer tubes. The present invention can not only maintain the convenience in use, but also save the consumption of resources, and increase the stability of structure.

### BRIEF DESCRIPTION OF THE DRAWINGS

The present invention will be apparent to those skilled in the art by reading the following detailed description of a preferred embodiment thereof, with reference to the attached drawings, in which:

FIG. 1A is an exploded schematic view according to a first embodiment of the present invention;

FIG. 1B is an enlarged schematic view showing that an outer tube insert is assembled with an outer tube according to the first embodiment of the present invention;

FIG. 2 is an enlarged schematic view according to the first embodiment of the present invention after assembled;

FIG. 3A is an enlarged longitudinal sectional view showing that the outer tube insert is assembled with the outer tube according to a second embodiment of the present invention;

FIG. 3B is an enlarged longitudinal sectional view showing that an internal threaded portion of a sleeve member and an external threaded portion of the outer tube insert are tightened with each other according to the second embodiment of the present invention;

FIG. 4A is a schematic view showing that the outer tube insert is assembled with the outer tube according to a third embodiment of the present invention;

FIG. 4B is an enlarged longitudinal sectional view showing that the outer tube insert is assembled with the outer tube according to the third embodiment of the present invention;

FIG. 5A is an enlarged schematic view of an inner tube pressed member according to a fourth embodiment of the present invention;

FIG. 5B is a schematic view showing that the inner tube pressed member is sleeved on an outer side of the inner tube according to the fourth embodiment of the present invention;

FIG. 5C is an enlarged sectional view showing that the inner tube pressed member and a pressing portion are released from each other according to the fourth embodiment of the present invention;

FIG. 5D is an enlarged sectional view showing that the inner tube pressed member is pressed by the pressing portion according to the fourth embodiment of the present invention;

FIG. 6 is an enlarged schematic view showing that the outer tube insert and the inner tube pressed member are formed as one piece according to a fifth embodiment of the present invention; and

FIG. 7 is a schematic view showing that the outer tube insert according to a sixth embodiment of the present invention is a sheet-shaped body.

### IN THE DRAWINGS

1: outer tube
11: receiving end
111: hole
2: inner tube
3: outer tube insert
31: external threaded portion
32: pressurizing portion
33: sheet-shaped body
4: sleeve member
41: internal threaded portion
42: pressing-accommodating portion
421: pressing portion
5: inner tube pressed member
51: pressed portion
511: groove

### DETAILED DESCRIPTION OF THE PREFERRED EMBODIMENT

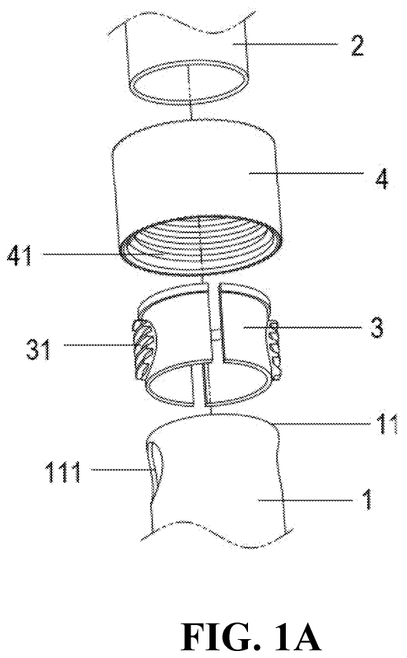

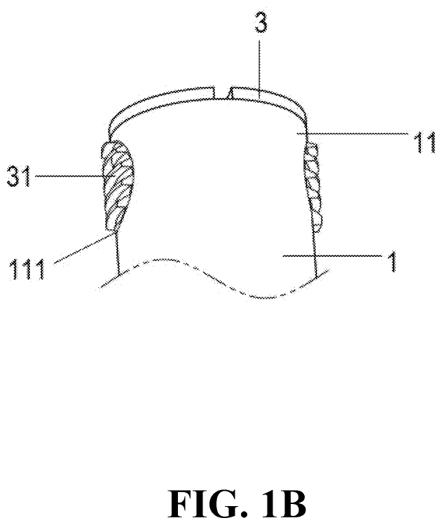

Hereinafter, the embodiments of the present invention will be described with reference to FIGS. 1A to 7. The description is not intended to limit the embodiments of the present invention, but belongs to one of the embodiments of the present invention.

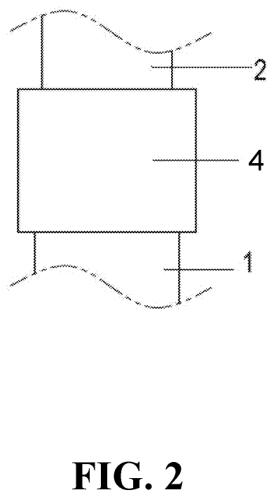

FIGS. 1A to 2 show a telescopic tube assembly having a fixing structure according to a first embodiment of the present invention, which comprises an outer tube 1, an inner tube 2, an outer tube insert 3, and a sleeve member 4. As shown in FIG. 1A, the outer tube 1 has a receiving end 11, wherein at least one hole 111 is disposed adjacent the receiving end 11; the outer diameter of the inner tube 2 is smaller than the inner diameter of the outer tube 1; the outer tube insert 3 may be accommodated in a gap between the outer tube 1 and the inner tube 2, and the outer tube insert 3 has at least one external threaded portion 31, wherein the number of the at least one external threaded portion 31 is less than or equal to the number of the at least one hole 111 on the outer tube 1, and positions of the at least one external threaded portion 31 and the at least one hole 111 are corresponding to each other; and the external threaded portion 31 may pass through the hole and a screw thread of the external threaded portion 31 protrudes out of the outer tube 1; and the sleeve member 4 is sleeved on an outer side of the outer tube 1, and has an internal threaded portion 41, wherein a screw thread of the internal threaded portion 41 has a shape corresponding to that of the external threaded portion 31, and the screw thread of the internal threaded portion 41 and the screw thread of the external threaded portion 31 can be tightened and loosened from each other. As shown in FIG. 1B, the outer tube insert 3 is placed inside the outer tube 1, the external threaded portion 31 passes through the hole 111, and then one end of the inner tube 2 passes through the receiving end 11 and is placed inside the outer tube 1, such that the outer tube insert 3 is accommodated between the outer tube 1 and the inner tube 2. As shown in FIG. 2, the sleeve member 4 is sleeved on the receiving end 11, wherein by rotating the sleeve member 4, the internal threaded portion 41 and the external threaded portion 31 are tightened with each other, such that the inner tube 2 and the outer tube 1 are fixed to each other; and by reversely rotating the sleeve member 4, the internal threaded portion 41 and the external threaded portion 31 are loosened from each other, such that the inner tube 2 and the outer tube 1 are movable relative to each other. The main objective of the present invention is that by forming a screw thread on the outer tube 1 in a simple manner, the screw thread can be tightened with the internal threaded portion 41 of the sleeve member 4, thereby achieving the effect of fixing the inner tube 2 and the outer tube 1 to each other in a resource saving way with a more stable structure.

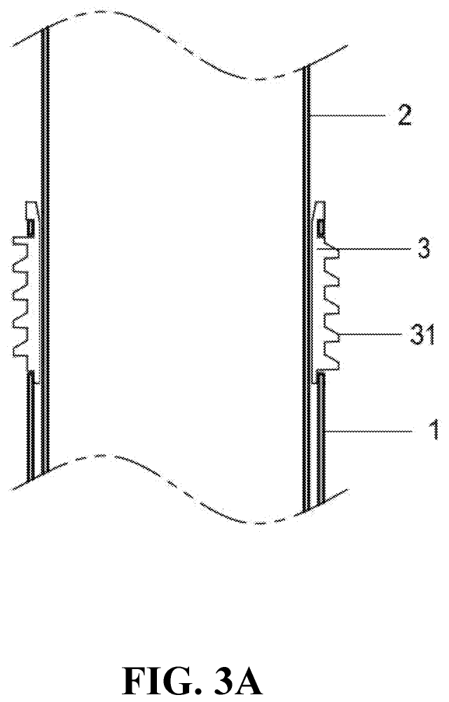

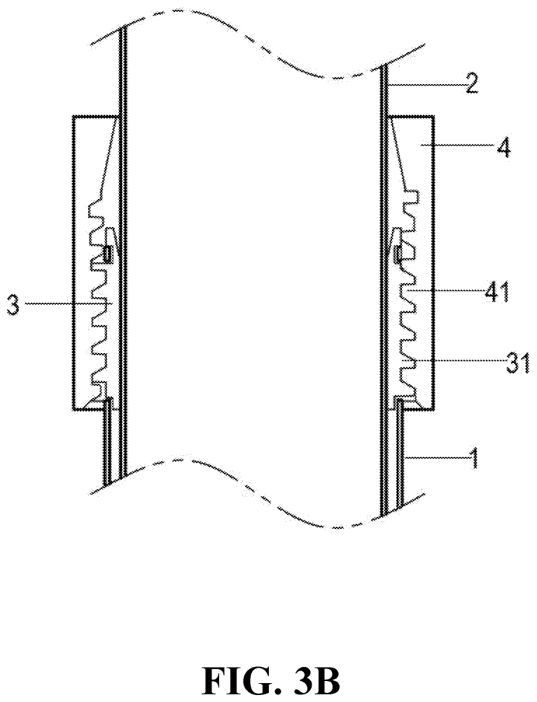

FIGS. 3A to 3B show a telescopic tube assembly having a fixing structure according to a second embodiment of the present invention. As shown in FIG. 3A, which is a longitudinal sectional view showing that the outer tube insert 3 is accommodated inside the outer tube 1, a screw thread of the external threaded portion 31 protrudes out of an outer edge of the outer tube 1. By rotating the sleeve member 4, the internal threaded portion 41 and the external threaded portion 31 are tightened with each other, such that as shown in FIG. 3B, the outer tube insert 3 is pressed by the sleeve member 4 through the external threaded portion 31, thereby making the outer tube insert 3 directly press against the inner tube 2 tightly, and fixing the inner tube 2 and the outer tube 1 to each other. On the other hands, by reversely rotating the sleeve member 4, the internal threaded portion 41 and the external threaded portion 31 are loosened from each other, such that as shown in FIG. 3A, the external threaded portion 31 is loosened from the sleeve member 4, thereby making the outer tube insert 3 no longer directly press against the inner tube 2, forming a gap between outer tube insert 3 and the inner tube 2, and allowing the inner tube 2 and the outer tube 1 to be movable relative to each other. In the second embodiment of the present invention, the objective of fixing the outer and inner tubes to each other can be achieved by making the internal threaded portion 41 of the sleeve member 4 press the external threaded portion 31. This is only one of the embodiments in which the inner tube 2 is directly tightly pressed by the outer tube insert 3. In practice, this effect is not limited to be achieved by making the internal threaded portion 41 press the external threaded portion 31.

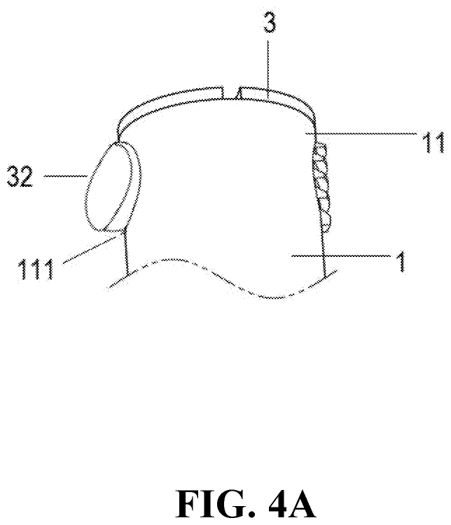

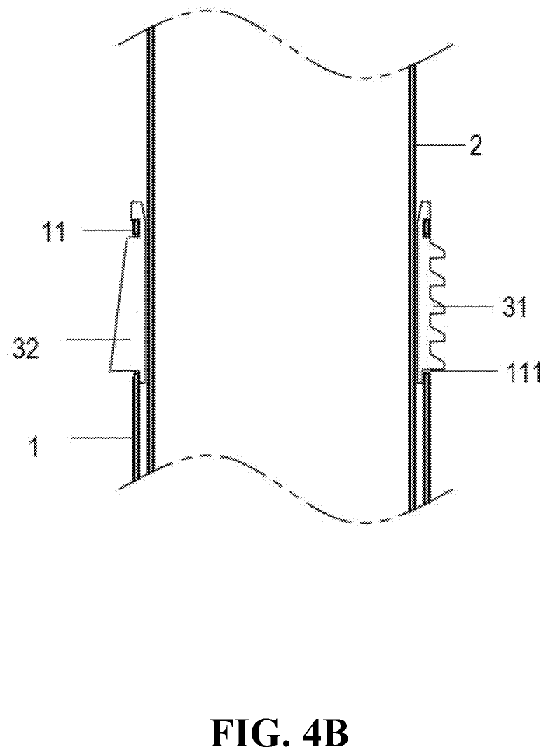

FIGS. 4A and 4B show a third embodiment which may be derived from the second embodiment of the present invention. As shown in FIG. 4A, the outer tube insert 3 is provided with the at least one external threaded portion 31 and at least one pressurizing portion 32. The pressurizing portion 32 and the external threaded portion 31 are similar, which are disposed at positions corresponding to the holes 111. As shown in FIG. 4B, the pressurizing portion 32 passes through the hole 111 and protrudes out of an outer edge of the outer tube 1. A protruding height of the pressurizing portion 32 gradually increases from the receiving end 11 toward the opposite end of the outer tube 1. The maximum protruding height of the pressurizing portion 32 is greater than an outer diameter of the external threaded portion 31. In the third embodiment of the present invention, the objective of fixing the outer and inner tubes can be achieved by tightening up the sleeve member 4 to make the internal threaded portion 41 press against the pressurizing portion 32, such that the outer tube insert 3 directly presses against the inner tube 2 tightly. This is another embodiment of the present invention, and the present invention is not limited thereto.

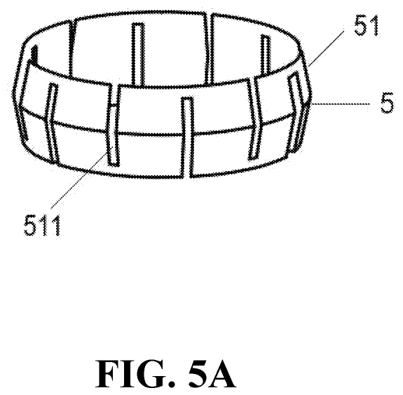

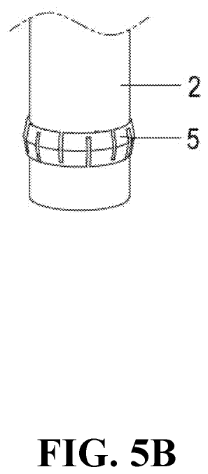

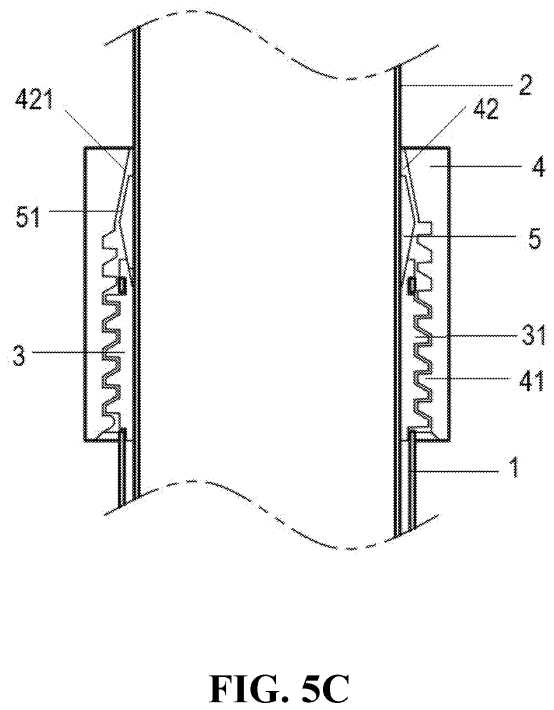

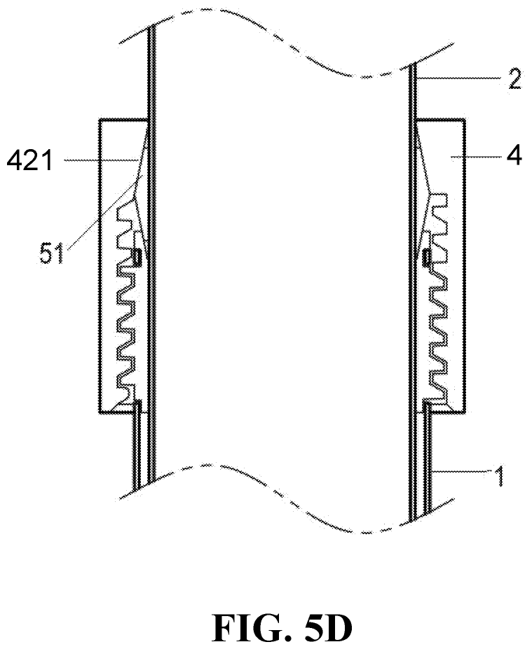

FIGS. 5A to 5D show a telescopic tube assembly having a fixing structure according to a fourth embodiment of the present invention. As shown in FIG. 5A, the telescopic tube assembly having the fixing structure further comprises an inner tube pressed member 5 having a pressed portion 51. As shown in FIG. 5B, the inner tube pressed member 5 is disposed around an outer side of the inner tube 2 and is movable relative to the inner tube 2 and accommodated in a pressing-accommodating portion 42 of the sleeve member 4. As shown in FIG. 5C, the pressing-accommodating portion 42 is provided with a pressing portion 421, and positions of the pressing portion 421 and the pressed portion 51 are corresponding to each other. As shown in FIG. 5D, by rotating the sleeve member 4, the internal threaded portion 41 and the external threaded portion 31 are tightened with each other, such that the pressed portion 51 is pressed by the pressing portion 421, thereby making the inner tube pressed member 5 directly press against the inner tube 2 tightly, and fixing the inner tube 2 and the outer tube 1 to each other. As shown in FIG. 5C, by reversely rotating the sleeve member 4, the internal threaded portion 41 and the external threaded portion 31 are loosened from each other, such that the external threaded portion 31 is loosened from the sleeve member 4, thereby making the pressed portion 51 no longer directly press against the inner tube 2, and allowing the inner tube 2 and the outer tube 1 to be movable relative to each other. In the fourth embodiment of the present invention, the objective of fixing the outer and inner tubes can be achieved by making the pressing portion 421 press the pressed portion 51, such that the inner tube pressed member 5 directly presses against the inner tube 2 tightly. In this embodiment, the internal threaded portion 41 and the external threaded portion 31 may solely provide for the function of tightening up the outer and inner tubes without producing the effect of pressing against the inner tube 2 by the outer tube insert 3. Alternatively, the effect of pressing against the inner tube 2 by the outer tube insert 3 can also be produced simultaneously; that is, the outer tube insert 3 and the inner tube pressed member 5 press the inner tube 2 simultaneously.

As shown in FIG. 5A, the inner tube pressed member 5 has one or more groove(s) 511. The groove 511 allows a sufficient space for the inner tube pressed member 5 to more closely conform to the inner tube 2 when the pressed portion 51 is pressed by the pressing portion 421, thereby enhancing the fixing effect of the telescopic tube assembly. The groove 511 is not limited to be provided at only one end of the inner tube pressed member 5 or at both ends thereof.

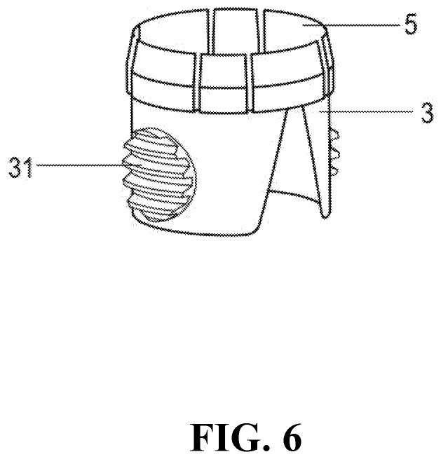

FIG. 6 shows a fifth embodiment of the present invention in which the inner tube pressed member 5 and the outer tube insert 3 are formed as one piece.

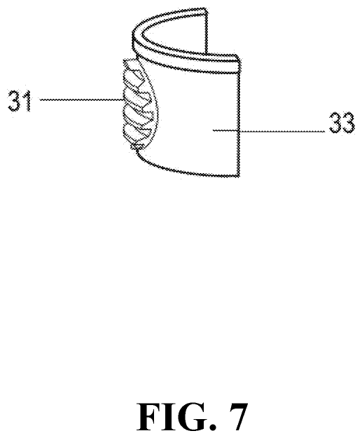

FIG. 7 shows a sixth embodiment of the present invention in which the outer tube insert 3 may be a sheet-shaped body 33. The outer tube insert 3 as illustrated in this embodiment is merely one of the shapes while the outer tube insert 3 of FIG. 1A according to the first embodiment of the present invention shown, which is an annular body with a notch, is another shape. As shown in FIG. 1, in practice, it is not limited to these two shapes, which may be modified according to needs.

The hole 111 of the present invention is also not limited to the circular shape shown in FIG. 1A, and its shape is not limited and may be any shape.

The external threaded portion 31 and the internal threaded portion 41 of the present invention are also not limited to have screw threads with a same height, and may be modified as different combinations according to needs.

The present invention can be applied in a wide range of field, for example, a telescopic tube assembly including but not limited to a central tube assembly and a support leg assembly of a tripod.

Although the present invention has been described with reference to the preferred embodiments thereof, it is apparent to those skilled in the art that modifications and changes to the appended claims and the above description made without departing from the inventive spirit of the present invention should fall within the scope of the present invention.

1. A telescopic tube assembly having a fixing structure, comprising:
an outer tube having a receiving end, wherein at least one hole is disposed adjacent to the receiving end;
an inner tube having an outer diameter smaller than an inner diameter of the outer tube;
an outer tube insert accommodated in a gap between the outer tube and the inner tube, and having at least one external threaded portion, wherein a number of the at least one external threaded portion is less than or equal to that of the at least one hole on the outer tube, and positions of the at least one external threaded portion and the at least one hole are corresponding to each other; and
the external threaded portion passes through the hole and a screw thread of the external threaded portion protrudes out of the outer tube; and
a sleeve member sleeved on an outer side of the outer tube, and having an internal threaded portion, wherein a screw thread of the internal threaded portion has a shape corresponding to that of the external threaded portion, and the screw thread of the internal threaded portion and the screw thread of the external threaded portion is capable of being tightened and loosened from each other;
wherein in assembling, the outer tube insert is placed inside the outer tube, the external threaded portion passes through the hole, and then one end of the inner tube passes through the receiving end and is placed inside the outer tube, such that the outer tube insert is accommodated between the outer tube and the inner tube; the sleeve member is sleeved on the receiving end, wherein by rotating the sleeve member, the internal threaded portion and the external threaded portion are tightened with each other, such that the inner tube and the outer tube are fixed to each other; and by reversely rotating the sleeve member, the internal threaded portion and the external threaded portion are loosened from each other, such that the inner tube and the outer tube are movable relative to each other.

2. The telescopic tube assembly having the fixing structure according to claim 1, wherein by rotating the sleeve member, the internal threaded portion and the external threaded portion are tightened with each other, such that the outer tube insert directly presses against the inner tube tightly, thereby fixing the inner tube and the outer tube to each other; and by reversely rotating the sleeve member, the internal threaded portion and the external threaded portion are loosened from each other, such that the external threaded portion is loosened from the sleeve member, thereby making the outer tube insert no longer directly press against the inner tube, and allowing the inner tube and the outer tube to be movable relative to each other.

3. The telescopic tube assembly having the fixing structure according to claim 1, further comprising an inner tube pressed member having a pressed portion, which is disposed around an outer side of the inner tube and is movable relative to the inner tube and accommodated in a pressing-accommodating portion of the sleeve member, wherein the pressing-accommodating portion is provided with a pressing portion, and positions of the pressing portion and the pressed portion are corresponding to each other, and wherein by rotating the sleeve member, the internal threaded portion and the external threaded portion are tightened with each other, such that the pressed portion is pressed by the pressing portion, thereby making the inner tube pressed member directly press against the inner tube tightly, and fixing the inner tube and the outer tube to each other; and by reversely rotating the sleeve member, the internal threaded portion and the external threaded portion are loosened from each other, such that the external threaded portion is loosened from the sleeve member, thereby making the inner tube pressed member no longer directly press against the inner tube, and allowing the inner tube and the outer tube to be movable relative to each other.

4. The telescopic tube assembly having the fixing structure according to claim 3, wherein the inner tube pressed member has one or more groove(s).

5. The telescopic tube assembly having the fixing structure according to claim 3, wherein the inner tube pressed member and the outer tube insert are formed as one piece.

6. The telescopic tube assembly having the fixing structure according to claim 1, wherein the outer tube insert is a sheet-shaped body.
